(19) United States
(12) Patent Application Publication
(10) Pub. No.: US 2014/0132555 A1
(43) Pub. Date: May 15, 2014

(54) METHOD FOR MAKING SECURE A CONTROL ON A VISUALIZATION DEVICE WITH A TACTILE SURFACE, AND ASSOCIATED SYSTEM

(71) Applicant: Thales, Neuilly sur Seine (FR)

(72) Inventors: Loïc BECOUARN, Pessac (FR); Yannick LE ROUX, St Medard en Jalles (FR); Sylvain HOURLIER, Bordeaux (FR); Alexandre ALAPETITE, Venlose (DK); Rune FOGH, Copenhague (DK); Henning Boje ANDERSEN, Roskilde (DK)

(21) Appl. No.: 14/066,622

(22) Filed: Oct. 29, 2013

(30) Foreign Application Priority Data
Nov. 9, 2012 (FR) 12/03013

(51) Int. Cl. G06F 3/0488

(52) U.S. Cl. CPC G06F 3/0488
USPC 345/174

(57) ABSTRACT

The general field of the invention is that of methods providing a secure control for an appliance by means of a visualization device having a tactile surface capable of detecting several simultaneous touches. The method according to the invention comprises:
A first step of displaying on the visualization device a first symbol representing the control in a locked state;
A second step of displaying, after a first touch on the tactile surface, a second symbol representing an “unlocking” gesture;
A third step of performing said “unlocking” gesture;
A fourth step of validating the command by two simultaneous touches at the sites of the first and second symbols;
A fifth step of changing the appearance of the first symbol representing the control to be activated in an unlocked and activated state.

The field of the invention is that of human-machine interfaces, known as “HMI”s, that require the validation of a critical action. In certain technical or industrial contexts, the implementation of systems can have serious consequences and requires the user to have full knowledge of the facts. Examples that may be cited include the aerospace and nuclear sectors.

In civil or military aircraft cockpits, the instrument panels have various means for interacting with the main systems of the aircraft, such as the on-board avionics, the engines, the weapon system etc.

When the action or the task is highly critical, these means for interacting must make it possible to avoid any unintentional control from the pilot or the crew. To this end, aircraft are equipped with covered switches called “guarded switches”. To perform the action, the user must first raise a protective mechanical cover to gain access to the control switch. The cover is equipped with a spring system which holds it in the safety position above the control switch if the user releases it.

Current development in human-machine interfaces consists in gradually replacing the mechanical or electromechanical control devices with controls provided by tactile interfaces arranged on visualization screens. The control switches are thus becoming virtual. This type of technical solution has many advantages. It is easier to implement and takes up a good deal less space than the old systems. It is much easier to reconfigure and able to evolve according to the needs of the aircraft manufacturer. It also enables access to new functions such as graphic animations.

Of course, the safety afforded by a virtual guarded switch controlled by a tactile surface must be at least identical to that of guarded switches with a mechanical cover. To solve this problem, several technical solutions have been proposed.

A first solution described in the French patent FR 2 911 409 entitled “Procédés et système assurant une commande sécurisée à partir d'un écran tactile” (Methods and system ensuring secure control from a tactile screen) presents a method for displaying a secure switch comprising a graphic representation of a guarded switch. Control of the switch is afforded by a first unlocking step and a second control step, the graphic representation being modified at each step. In a variant, the patent U.S. Pat. No. 7,788,604 entitled “Three state icons for operations” presents an icon having three states, a locked state, an unlocked state and a control state.

A second solution is described in the French patent FR 2 853 095 “Dispositif d'interface homme machine sécurisé pour écran tactile” (Secure human-machine interface device for tactile screen). This solution also describes a representation of a guarded switch controlled by a tactile surface. In this solution, the operator must perform a movement with a particular geometrical shape to unlock the guarded switch.

A third solution making it possible to validate an action of the user as not being accidental or due to external causes is described in the patent U.S. Pat. No. 5,801,682 entitled “Tactile designation device with high-resolution transparent capacitive surface” and consists in realizing two different tactile pressure detection modes, the first of capacitive type, the second using strain gauges, with the detection of an action by a first detection mode having to be confirmed by the second mode to validate the action.

A fourth solution consists in validating an action on the condition that it responds to a movement of predefined shape. In this category may be cited the patent U.S. Pat. No. 5,252,951 entitled “Graphical user interface with gesture recognition in a multi-application environment”, the patent application US 2010/0162182 entitled “Method and apparatus for unlocking electronic appliance” and the patent application EP 2009/062682 entitled “Method for application launch and system function invocation”. This last solution is generally dedicated to mobile telephony applications.

A fifth solution, which is a variant of the previous solutions, consists in graphically indicating to the user the gesture to carry out to unlock a particular function. In this category may be cited the patent U.S. Pat. No. 7,657,849 entitled “Unlocking a device by performing gestures on an unlock image” and the patent application US 2010/0248689 entitled “Unlock screen”, which describes a particular animation enabling passage from one graphic page to the next. Finally, the patent U.S. Pat. No. 7,593,000 describes a method enabling the storage in memory of a particular gesture for authentication. In the neighbouring field of motor vehicles, motion detection is also used to perform controls. One may in particular refer to the patent applications US 2011/0050589 entitled “Gesture-based information and command entry for motor vehicle” and WO 2011/083212 entitled “Control device for a motor vehicle”.

The method according to the invention also provides secure control from a tactile screen. In order to ensure both optimum security and a mode of operation that is easily understood by the user, it combines several principles, which are as follows:
Several distinct steps are necessary to unlock a control switch;
Setup of a particular symbol indicating to the user the gesture to make;
Use of at least two of the user's fingers to implement the method in order to make it secure.

More precisely, the subject of the invention is a display and activation method providing a secure control for an appliance implemented by an electronic system comprising at least means for generating graphic symbols, a visualization device and a tactile surface associated with said visualization device and arranged in such a way as to detect several simultaneous touches, characterized in that the display and activation method comprises:
A first step of displaying on the visualization device a first symbol representing the control to be activated in a locked state;
A second step of displaying, after a first touch on the tactile surface, at least one second symbol that is representative of a so-called “unlocking” gesture to make to obtain the unlocking of said control;
A third step of performing said “unlocking” gesture;
A fourth step of validating the command by at least two simultaneous touches, the first at the site of the first symbol and the second at the site of the second symbol;
A fifth step of changing the appearance of the first symbol representing the control to be activated in an unlocked and activated state.

Advantageously, the first symbol represents a control button in a first state or a rectilinear cursor.

Advantageously, the second symbol displayed in the second step represents a simple coloured geometrical shape or a control button in a second state or the outline of the gesture to carry out.

Advantageously, the gesture to carry out in the third step is a single long press or a rectilinear movement or a semi-circular movement.

Advantageously, the fourth step of validating the command is effective only after a predetermined time of simultaneous touches.

Advantageously, during the fourth step of validating the control, an indicator of the time elapsed is displayed, the length of the indicator corresponding to the predetermined time of simultaneous touches.

Advantageously, the fourth step of validating the command is effective only after three simultaneous touches.

The invention also relates to an electronic system for aircraft comprising at least means for generating graphic symbols, a visualization device and a tactile surface associated with said visualization device and arranged in such a way as to detect several simultaneous touches, characterized in that a secure control for an aeronautical appliance is activated by the display and activation method described above.

The invention will be better understood and other advantages will emerge on reading the following description, which is in no way limiting and makes reference to the appended drawings, among which:

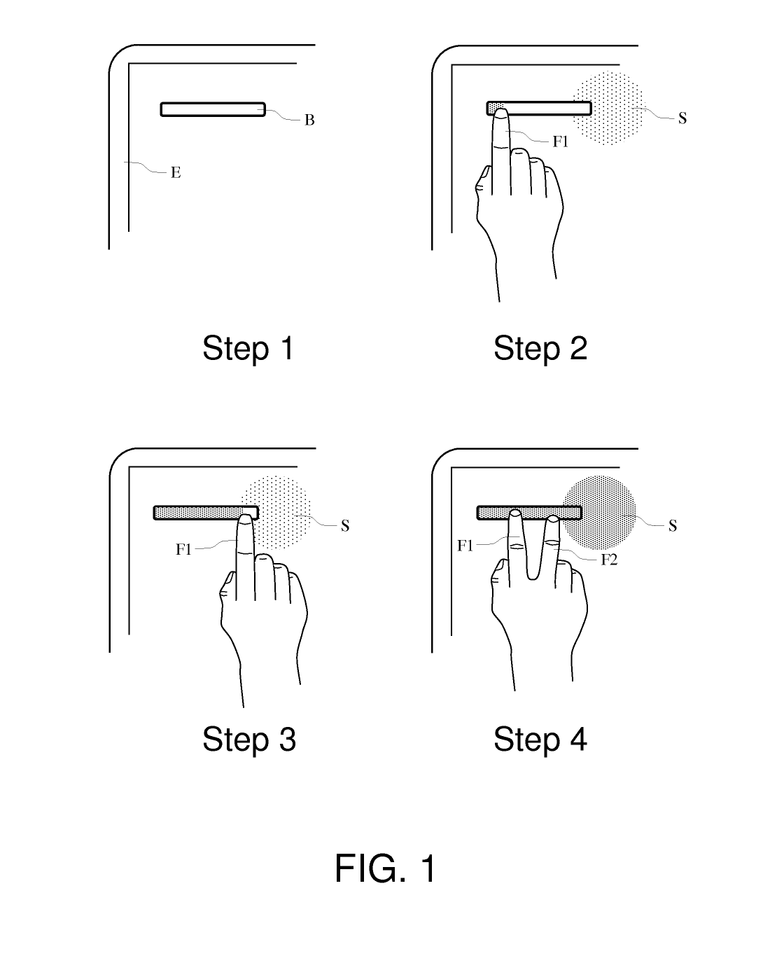

FIG. 1 shows four main steps of a first embodiment of the method according to the invention;

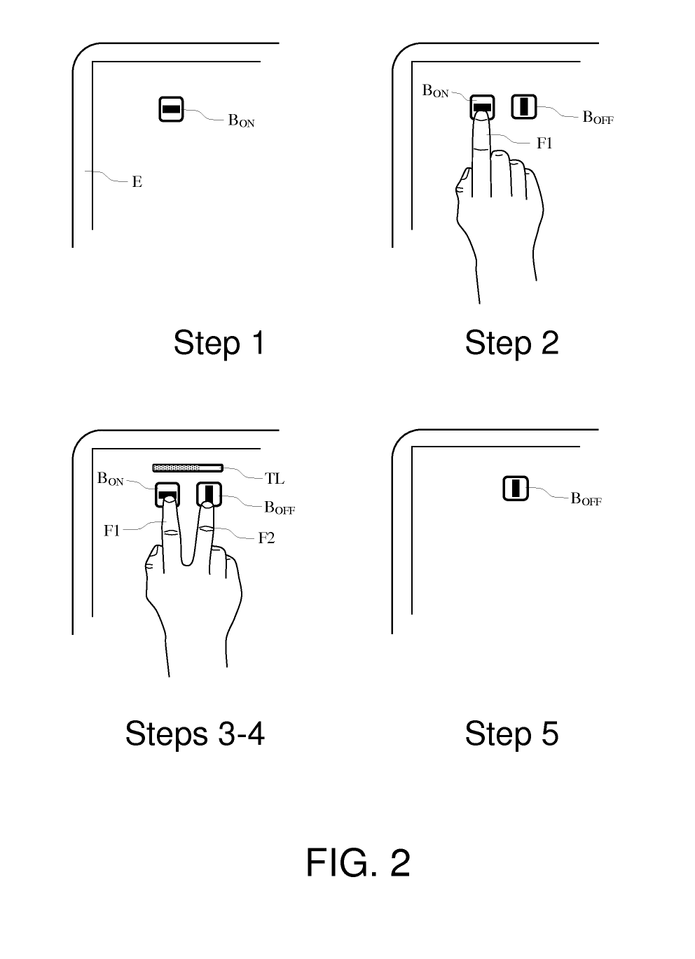

FIG. 2 shows four main steps of a second embodiment of the method according to the invention;

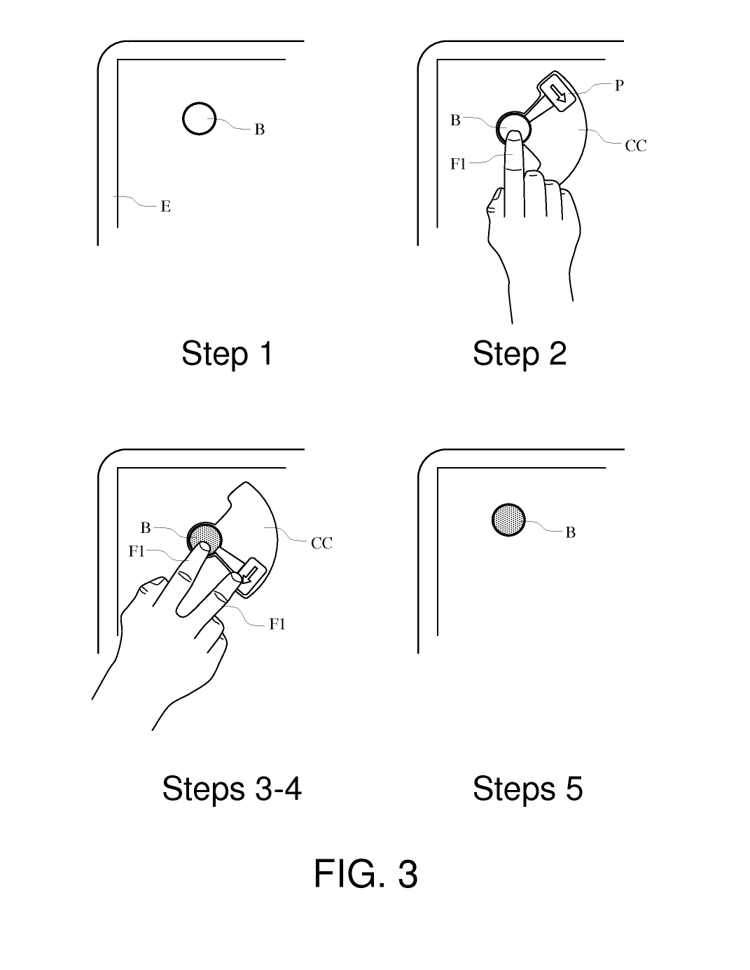

FIG. 3 shows four main steps of a third embodiment of the method according to the invention;

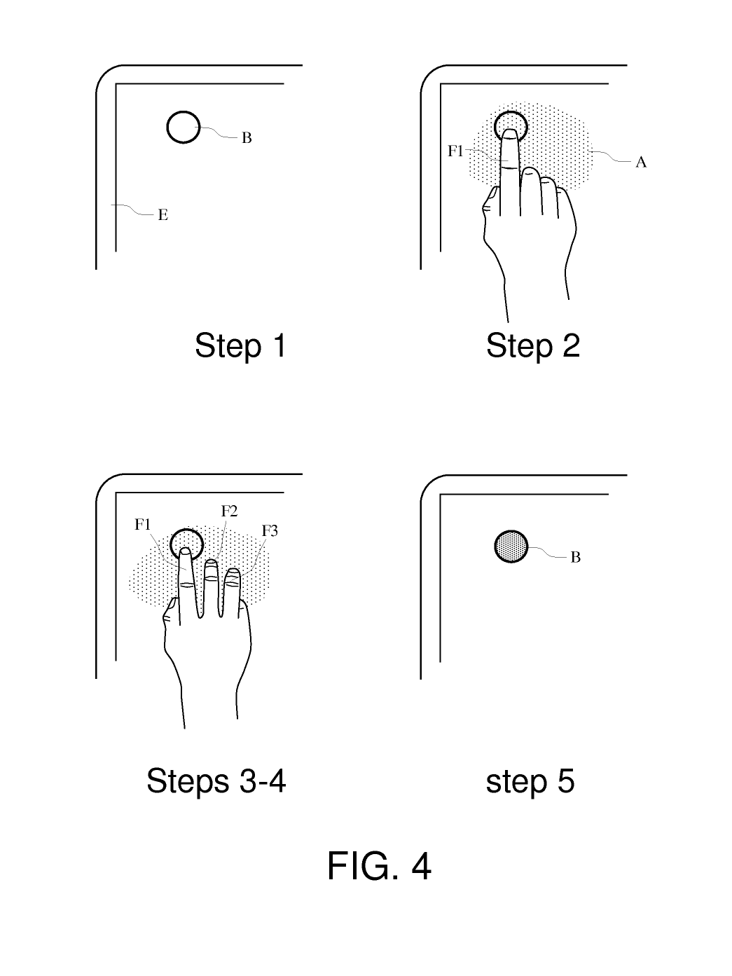

FIG. 4 shows four main steps of a fourth embodiment of the method according to the invention.

The implementation of the display and activation method providing a secure control according to the invention requires means for generating graphic symbols, a visualization device and a tactile surface associated with the visualization device and arranged in such a way as to detect several simultaneous touches, also called “Multi-touch”. These technical means are easily available to those skilled in the art.

The implementation of the method involves the programming of a piece of software configured to perform the various steps of the method. It does not present any particular difficulties to those skilled in the art. As has been said, the display and activation method comprises five steps which are:
A first step of displaying on the visualization device a first symbol representing the control to be activated in a locked state;
A second step of displaying, after a first touch on the tactile surface, at least one second symbol that is representative of a so-called “unlocking” gesture to make to obtain the unlocking of said control;
A third step of performing said “unlocking” gesture;
A fourth step of validating the command by at least two simultaneous touches, the first at the site of the first symbol and the second at the site of the second symbol;
A fifth step of changing the appearance of the first symbol representing the control to be activated in an unlocked and activated state.

By way of example, FIGS. 1 to 4 show four possible implementations of the method according to the invention. Each figure has four drawings, each showing the main steps of the method according to the invention. In these figures, only a screen edge E has been shown that has only the graphic symbols necessary for the implementation of the various steps of the method. The control buttons to be activated are shown with a bold outline.

A first variant shown in FIG. 1 shows the unlocking of a control button B in the form of a cursor. In a first step, the cursor B is displayed on the visualization screen E. In a second step, a finger F1 of the user touches one of the ends of the cursor. A coloured or semi-transparent circle S appears, telling the user to run their finger F1 linearly along the cursor B. In a third step, the finger F1 runs along the cursor. When it arrives at the end of the cursor, the symbol S changes colour or transparency, indicating that the unlocking of the cursor may be carried out. In a fourth step, two fingers F1 and F2 of the user press the cursor B and the symbol S simultaneously against, leading to the unlocking of the control.

A second variant shown in FIG. 2 shows the change of state of a control changing from an on state to an off state. In a first step, the on state is represented by a square button B_{ON} having a horizontal black bar on the visualization screen E. In a second step, a finger F1 of the user touches this button. A square button B_{OFF} having a vertical black bar on the visualization screen E appears. In a third step, the user presses two fingers F1 and F2 against the buttons B_{ON} and B_{OFF}. An indicator of the time elapsed TL is displayed, the length of the indicator corresponding to a predetermined time of the simultaneous taps, which may be a few hundreds of milliseconds. In a fourth step, the predetermined time has elapsed, leading to the unlocking of the control. In a fifth step, only the square button B_{OFF} is displayed.

A third variant shown in FIG. 3 shows the unlocking of a circular control button B. In a first step, the button B is displayed on the visualization screen E. In a second step, a finger F1 of the user touches the button B. A coloured or semi-transparent quarter-circle CC appears. This has a pivot P centred on the button B and having an arrow at its end, telling the user to turn this pivot P. In a third step, the user uses two fingers F1 and F2 to turn the pivot P, the first stationary finger centred on the switch and the second moving finger moving the pivot. In a fourth step, the pivot arrives at the end of its course, leading to the unlocking of the control. In a fifth step, the button B changes appearance, indicating that the activation of the button B is effective.

A fourth variant shown in FIG. 4 also shows the unlocking of a circular control button B. In a first step, the button B is displayed on the visualization screen E. In a second step, a finger Fl of the user touches the switch B. A coloured area A appears around the button B. In a third step, the user presses three fingers F1, F2 and F3 in the area A. In a fourth step, the user holds his three fingers down for a predetermined time period, which may be a few hundreds of milliseconds, validating the unlocking of the button B. In a fifth step, the button B changes appearance, indicating that the activation of the button B is effective.

1. Display and activation method providing a secure control for an appliance implemented by an electronic system comprising at least means for generating graphic symbols, a visualization device and a tactile surface associated with said visualization device and arranged in such a way as to detect several simultaneous touches, wherein the display and activation method comprises:
A first operation of displaying on the visualization device a first symbol representing the control to be activated in a locked state;
A second operation of displaying, after a first touch on the tactile surface, at least one second symbol representative of a so-called “unlocking” gesture to make that is to obtain the unlocking of said control;
A third operation of performing said “unlocking” gesture;
A fourth operation of validating the command by at least two simultaneous touches, the first at the site of the first symbol and the second at the site of the second symbol;
A fifth operation of changing the appearance of the first symbol representing the control to be activated in an unlocked and activated state.

2. Display and activation method according to claim 1, wherein the first symbol represents a control button in a first state or a rectilinear cursor.

3. Display and activation method according to claim 1, wherein the second symbol displayed in the second operation represents a simple coloured geometrical shape or a control button in a second state or the outline of the gesture to carry out.

4. Display and activation method according to claim 1, wherein the gesture to carry out in the third operation is a single long press or a rectilinear movement or a semi-circular movement.

5. Display and activation method according to claim 1, wherein the fourth operation of validating the command is effective only after a predetermined time of simultaneous touches.

6. Display and activation method according to claim 5, wherein, during the fourth operation of validating the command, an indicator of the time elapsed is displayed, the length of the indicator corresponding to the predetermined time of simultaneous touches.

7. Display and activation method according to claim 1, wherein the fourth operation of validating the command is effective only after three simultaneous touches.

8. Electronic system for aircraft comprising at least means for generating graphic symbols, a visualization device and a tactile surface associated with said visualization device and arranged in such a way as to detect several simultaneous touches, wherein secure control for an aeronautical appliance is activated by a display and activation method providing a secure control for an appliance implemented by an electronic system comprising at least means for generating graphic symbols, a visualization device and a tactile surface associated with said visualization device and arranged in such a way as to detect several simultaneous touches, wherein the display and activation method comprises:
A first operation of displaying on the visualization device a first symbol representing the control to be activated in a locked state;
A second operation of displaying, after a first touch on the tactile surface, at least one second symbol representative of a so-called “unlocking” gesture to make that is to obtain the unlocking of said control;
A third operation of performing said “unlocking” gesture;
A fourth operation of validating the command by at least two simultaneous touches, the first at the site of the first symbol and the second at the site of the second symbol;
A fifth operation of changing the appearance of the first symbol representing the control to be activated in an unlocked and activated state.
